(19) United States
(12) Patent Application Publication
(10) Pub. No.: US 2012/0180521 A1
(43) Pub. Date: Jul. 19, 2012

(54) Flue Gas Scrubbing with Aqueous Ammonia

(76) Inventor: Donald Charles Erickson, Annapolis, MD (US)

(21) Appl. No.: 13/374,838

(22) Filed: Jan. 18, 2012

Related U.S. Application Data
(60) Provisional application No. 61/461,470, filed on Jan. 18, 2011.

(51) Int. Cl. F25J 3/08; B01D 19/00; B01D 53/14

(52) U.S. Cl. 62/617; 96/242; 96/181; 95/179

(57) ABSTRACT

A system for scrubbing acid gases from a gas stream, and particularly adapted for scrubbing CO2 from flue gas and recovering the CO2 at high pressure and good purity using an aqueous scrubbing medium such as aqueous ammonia scrubbing solution. A scrubber, regenerator, and stripper are provided, with each having two parts that are each multistage countercurrent vapor-liquid contactors. The required compression energy is minimized by providing necessary refrigeration from an ammonia absorption refrigeration plant that is powered by heat extracted from the gas being scrubbed. The amount of reboil required for the regenerator and stripper is minimized by providing internal heat exchangers (non-adiabatic distillation) in those components.

### FIELD OF INVENTION

Removing carbon dioxide from a gas stream such as flue gas, and recovering it at good purity and higher pressure.

### BACKGROUND

Aqueous ammonia solutions have been found to be advantageous media for scrubbing acid gases from low pressure gases having acid gas as a minor constituent. Primary interest is focused on carbon dioxide, as the major constituent of the acid gas, and implicated in global warming. The objective is to efficiently remove the CO2, typically about 90% removal, without leaving any significant concentration of ammonia in the cleaned gas. Further it is desired to minimize the energy cost of driving the removal process, including the step of pressurizing the CO2 to high pressure for disposal or other use. Much of the energy required for conventional CO2 removal processes is for the regeneration of the scrubbing medium, the removal of trace medium from the flue gas, and compression of the recovered CO2. It is desired to make each of those steps more energy efficient.

Kohl and Riesenfeld 1985 4^{th} edition disclose traditional approaches to scrubbing CO2 from a gas with aqueous ammonia scrubbing solutions. Disclosed in chapter 4 are the use of multistage countercurrent vapor-liquid mass exchangers (absorbers) having liquid recirculation and external cooling for each stage; the use of a steam reboiled regeneration column to recover the CO2 and replenish the scrubbing medium; and the use of a separate countercurrent vapor liquid mass exchange column (water wash column) to remove trace ammonia from the scrubbed gas.

Wibberley (U.S. Patent Application 2010/0267123) discloses a pressurized ammonia flue gas scrubbing process wherein the flue gas is pressurized by a compressor and the scrubbing is done in a multistage countercurrent vapor liquid contactor with a recirculated liquid external cooler for one of the stages. This reduces ammonia slip.

Koss and Kozak (U.S. Patent Application 2010/0107875) disclose a chilled ammonia flue gas scrubbing process wherein the flue gas is contacted in a multistage countercurrent vapor liquid contactor with one stage of liquid recirculation and chilling, followed by a separate multistage countercurrent vapor liquid contactor for water washing with chilled water. The concentration and temperature of the scrubbing is such that solid ammonium bicarbonate forms, that is removed in a cyclone and sent to regeneration. Wash water is reclaimed in a low pressure steam reboiled column (stripper), and the ammonia in the stripped gas ammonia content is recovered in a multistage vapor liquid contactor by the same scrub medium as that supplied to the absorber. The regenerator is operated at substantially elevated pressure.

Gal et al (U.S. Patent Application 2009/0101012) disclose a multistage countercurrent vapor liquid contactor for flue gas scrubbing having chilled liquid recirculation for each stage.

Kang et al (U.S. Patent Application 2008/0307968) disclose an ammonia flue gas scrubbing process comprised of a scrubbing column—a single multistage countercurrent vapor liquid contactor having a multistage absorbing section and a water wash section, all in countercurrent vapor liquid mass exchange relationship and with cooled liquid recirculation. Also disclosed is a concentration column that has both water recovery section and ammonia recovery section in mutual countercurrent vapor liquid contact relationship. Also disclosed is a regeneration column having both regeneration and water wash sections in countercurrent vapor liquid contact relationship.

Gal et al (U.S. Pat. No. 7,846,240) disclose a chilled ammonia flue gas scrubbing system with absorber, water wash stripper, and regenerator, wherein the water wash stripper is a multistage countercurrent vapor liquid contactor with chilled liquid recirculation.

Gal et al (U.S. Pat. No. 7,641,717) disclose chilled washing of the flue gas after CO2 scrubbing to reduce ammonia slip.

Yeh and Pennline (U.S. Pat. No. 7,255,842) disclose a chilled ammonia CO2 scrubbing process where the CO2 is recovered as an ammonium salt, and with a water wash contactor for reducing ammonia slip.

Ijima (U.S. Pat. No. 6,764,530) discloses using exhaust heat and CO2 scrubber regeneration reject heat to make hot water.

The following problems are encountered in the prior art disclosures. The original problems were that there was not high enough CO2 recovery (90% typically desired) and/or too much ammonia slip in the discharge gas. The measures introduced to solve those problems created other problems.
1. Too much compression required (flue gas compression, CO2 compression, and refrigeration compression—both a cost and an electric parasitic demand problem).
2. Too much reboil heat required at the regenerator and/or the stripper.
3. Solids handling difficulties.

### DISCLOSURE OF INVENTION

A flue gas CO2 scrubbing process is disclosed comprised of a two-part scrubber; a two-part regenerator; and a two-part stripper. Each of the six parts is a multistage countercurrent vapor liquid contactor.

The scrubber is comprised of an absorber followed by a flue gas water wash column. They preferably operate at slightly above atmospheric pressure (e.g. 1.5 atmospheres absolute (ATA)), and at slightly above ambient temperature, e.g. 20° C. to 40° C. Fresh scrubbing solution is supplied to the overhead of the absorber, and loaded (depleted) scrubbing solution is withdrawn from the bottom and both recirculated plus sent to the regenerator. Fresh wash water is supplied to the overhead of the flue gas water wash column, and depleted wash water is withdrawn from the bottom and sent to the stripper.

The regenerator is comprised of a CO2 desorber followed by a CO2 water wash column. They preferably operate at about 20 ATA (in the range of 8 to 30 ATA). The desorber is reboiled by steam at a pressure higher than the desorber pressure. The CO2 water wash column overhead temperature is slightly above ambient temperature. Depleted scrubbing solution is supplied to the overhead of the desorber, and fresh scrubbing solution is withdrawn from the bottom. Fresh wash water is supplied to the overhead of the CO2 water wash column, and depleted wash water is withdrawn from the bottom and sent to the stripper.

The stripper is comprised of a water reclaimer followed by an ammonia reclaimer. They preferably operate at about three ATA (in the range of 2 to 4 ATA). The water reclaimer is reboiled by low pressure steam or other low temperature exhaust heat. Depleted wash water from both water wash columns is supplied to the water reclaimer overhead, and fresh wash water is withdrawn from the bottom and sent to both water wash columns. Fresh scrubbing solution is supplied to the overhead of the ammonia reclaimer, and depleted scrubbing solution from the bottom of the ammonia reclaimer is recycled to the regenerator. The remaining overhead vapor from the stripper is fed to the scrubber.

It is desirable to avoid the formation of ammonium solids in any of the contactors. Solids can form when the ammonium and CO2 concentrations are high and the temperature is low. The two wash columns are operated at low temperature (near ambient), but with low ammonium concentration (less than 4%, and as low as 0.1% in the fresh wash water). The water reclaimer operates both at high temperature and at dilute concentration, so solids are not an issue. The CO2 desorber operates at high concentration, but at high enough temperature that solids do not form. Hence the only two contactors with a solids issue are the absorber and the NH3 reclaimer. In both of those the concentration is carefully controlled to not be too high at the operating temperature such that solids could form. That generally means ammonium concentrations in the range of 10 to 22% (at least above 7%). Keeping these columns somewhat above ambient temperature allows that concentration to be higher than if they were chilled to below ambient.

It is desirable to minimize or eliminate the amount of compression required by the overall scrubbing process. That includes flue gas compression, CO2 compression, and refrigeration compression. Flue gas compression is minimized by operating the scrubber close to atmospheric pressure. CO2 compression is eliminated by operating the regenerator at elevated pressure, and then condensing the pressurized CO2 product with refrigeration provided by an exhaust heat powered absorption refrigeration unit. Refrigeration compression is eliminated by operating the wash columns at close to atmospheric temperature, operating the absorption column slightly above atmospheric temperature such that most or all of its cooling can be provided by cooling water, and providing any necessary chilling from waste heat powered ammonia absorption refrigeration. In summary, four of the six contactors operate with overhead temperature close to ambient, and the remaining two (desorber and water reclaimer) operate at elevated temperature (both are reboiled by steam or waste heat). Three of the six contactors operate at dilute concentration (0.1 to 4%), and the remaining ones (absorber, desorber, and NH3 reclaimer) operate at concentrations above 7%. These conditions are selected to minimize or eliminate compression requirements, and to avoid solids formation in any of the contactors. However they can cause high heat demand in the reboilers, especially if only conventional contactors are used. Thus one key aspect of this disclosure is the means for minimizing that heat demand.

The reboiler heat demand for the desorber and the water reclaimer is minimized by providing non-adiabatic contactors for those services that recover heat or cold from the liquids supplied to or removed from the contactors. In particular, for the desorber, the hot bottom product (fresh scrubbing solution) is withdrawn from the column through an internal heat exchanger, such that it provides part of the reboil to the column as it is cooled, and hence reduces the steam reboil requirement. The same is done at the water reclaimer—the hot fresh wash water bottom product is withdrawn through an internal heat exchanger to provide reboil to that column.

The reboil demand is also impacted by how cold the feed liquid is relative to the temperature at the feed location. That is conventionally minimized by heat exchange between the feed liquid and the hot bottom product. However the feed liquid flow is higher than the bottom product flow, and hence the feed cannot be heated to as high a temperature as desired. Another key aspect of this disclosure is the means of minimizing that shortfall. That is done by supplying at least part of the feed liquid to an internal heat exchanger in the contactor above (fed vapor from) the reboiled contactor. The remaining feed liquid is supplied to the conventional feed/effluent heat exchanger, but now the flow rates are more nearly balanced, so a better temperature approach is possible. In particular, part of the depleted scrubbing solution is fed to a heat exchanger inside the CO2 water wash column, thus helping to cool that contactor while heating up the depleted scrub solution. Similarly, part of the depleted wash water from the flue gas water wash column and/or the CO2 water wash column is fed to a heat exchanger inside the ammonia reclaimer to help keep the ammonia reclaimer cool and preheat the depleted wash water before feeding into the water reclaimer.

The prior art discloses non-adiabatic multistage contactors for the absorber and the flue gas water wash column. Since they are typically packed columns, the heat exchange is conducted external to each stage of packing using liquid recirculation. What this disclosure adds to that scheme is to make the remaining four contactors non-adiabatic also. Additionally, those four contactors are preferably trayed columns such that the necessary heat exchange can be inside the column and not require external liquid recirculation. The heat exchange is located on multiple trays in each column, with the tray heat exchangers connected in series in each column.

### BRIEF DESCRIPTION OF THE DRAWINGS

FIG. 1 is a first embodiment of the invention.

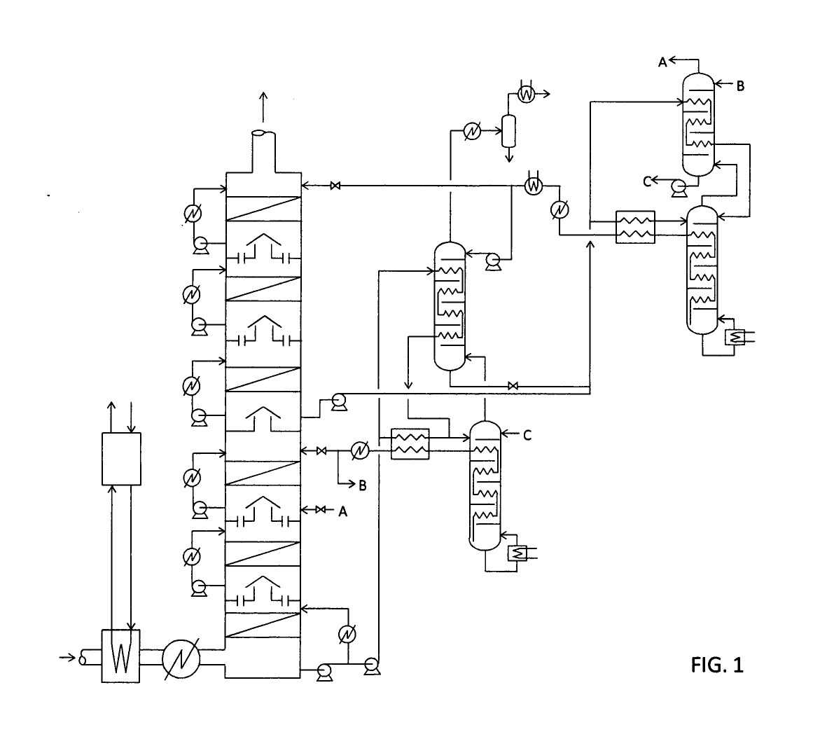

FIG. 2 adds captions to the major components of the FIG. 1 flowsheet.

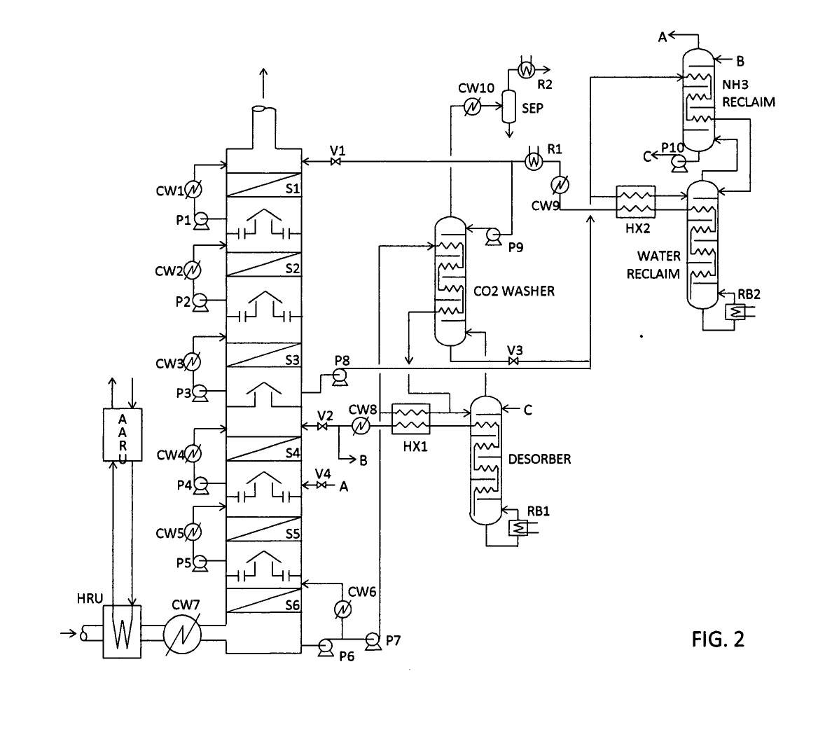

### DETAILED DESCRIPTION OF THE INVENTION

The flue gas scrubber is comprised of six stages of contact media S1 through S6, with the first three comprising the flue gas water wash section, and the lower three the absorber. Each stage of packing preferably includes a liquid recirculation pump P1 through P6, a cooling water cooler CW1 through CW6, plus the liquid collection pan below each contact section. Note that liquid is allowed to drain from only four of those pans. The incoming flue gas is optionally scrubbed of fouling species and cooled before entering the scrubber, including cooling by CW7 and recovery of useful heat by the heat recovery unit, as one preferred means of powering the ammonia absorption refrigeration unit that supplies refrigeration to the process. The absorber is linked by a liquid circulation path with the desorber, part of the regenerator. Depleted scrubbing medium is circulated to the desorber via high pressure pump P7, feed/effluent heat exchanger HX1, and the internal heat exchangers in the CO2 washer. The fresh scrubbing medium, after being stripped of CO2, is withdrawn via internal heat exchangers in the deorber, and then via HX1, cooler CW8 and valve V2 back to the absorber to absorb more CO2. The desorber is reboiled by reboiler RB1. The overhead vapor from the desorber is sent to the CO2 washer, where essentially all of the ammonia and most of the H2O is washed out of the high pressure CO2.

The water wash section of the scrubber is supplied fresh wash water overhead (a dilute solution of ammonium carbonate, with less than 4% ammonia content). The depleted wash water is pressurized to 2 to 4 ATA by pump P8 and circulated to the water reclaimer, part of the stripper. It is joined by the depleted wash water from the CO2 washer, via pressure reduction valve V3. The circulation path includes HX2 and preferably the internal heat exchanger inside the non-adiabatic column NH3 reclaimer. The water reclaimer is reboiled by RB2, using low pressure steam or waste heat. The fresh wash water, after being stripped of ammonia and CO2, is routed back to the two washers via HX2, cooler CW9, and optional chiller R1. The portion of the fresh wash water that is routed to the CO2 washer is pressurized to that column pressure by pump P9, and the portion routed to the flue gas washer is reduced in pressure at valve V1.

The overhead vapor from the water reclaimer is routed to the ammonia reclaimer, where it is contacted with fresh scrubbing medium from the desorber, and it returns depleted scrubbing medium to the desorber via pump P10. The remaining purge gas from the NH3 reclaimer overhead is routed to the absorber. The overhead vapor from the CO2 washer is subjected to further removal of trace water, by any of cooling, chilling, and/or glycol treatment. Then after water separation it is sent to a refrigerated condenser R2, supplied refrigeration by the AARU.

The combination of diabatic columns for the regenerator and stripper, plus optimal selection of tray count, yields reboil savings on the order of 20 to 30%. There is also a reduced number of trays, compared to the conventional adiabatic case. The use of the AARU for chilling and refrigeration provides savings on the order of 70 to 90% of the amount of compression power and capital equipment. The disclosed apparatus and process can utilize aqueous scrubbing media other than aqueous ammonia.

1. An apparatus for removing carbon dioxide from a gas comprising:
a. a two-part gas scrubber comprised of an absorber and a gas water washer;
b. a two-part regenerator comprised of a reboiled desorber and a CO2 water washer;
c. a two-part stripper comprised of a reboiled water reclaimer and an ammonia reclaimer;
d. a circulation path for carbon dioxide scrubbing liquid between said absorber and said desorber; and
e. a circulation path for wash water between said water reclaimer and said water wash contactor and water wash column.

2. The apparatus of claim 1 wherein each of the absorber, gas water washer, desorber, CO2 water washer, water reclaimer, and ammonia reclaimer is a multistage countercurrent vapor-liquid contactor.

3. The apparatus of claim 2 additionally comprised of a cooling water cooler for the water reclaimer bottom product, followed by a chiller, in said wash water circulation path; plus a waste heat powered ammonia absorption chiller for supplying chilling to said chiller.

4. The apparatus of claim 1 additionally comprised of a circulation path for scrubbing medium between said desorber and said ammonia reclaimer.

5. The apparatus of claim 2 wherein said desorber is a non-adiabatic trayed column, and additionally comprising internal heat exchangers on at least some of the trays.

6. The apparatus of claim 5 wherein the lowest of said heat exchangers is in liquid communication with bottom liquid from said desorber.

7. The apparatus of claim 2 wherein said CO2 washer is a non-adiabatic trayed column, and additionally comprising internal heat exchangers on at least some of the trays that are supplied at least part of the feed scrubbing medium for the desorber.

8. The apparatus of claim 2 wherein the water reclaimer is a non-adiabatic trayed column comprised of heat exchangers on at least part of the trays, with bottom product withdrawn through said heat exchangers.

9. The apparatus of claim 2 wherein the ammonia reclaimer is a non-adiabatic trayed column comprised of internal heat exchangers on at least part of the trays, and wherein at least part of the feed to the water reclaimer is connected to said heat exchangers.

10. The apparatus of claim 1 additionally comprised of a refrigerated condenser for condensing the recovered CO2 from the CO2 washer, plus an ammonia absorption refrigeration plant powered by heat from said gas that supplies the refrigeration to said condenser.

11. An apparatus for regenerating a liquid scrubbing medium for scrubbing acid gas, comprising a trayed reboiled stripping column with internal heat exchangers on at least some of said trays, plus a liquid flowpath for withdrawing the regenerated scrubbing liquid from the bottom of said stripper through said heat exchangers.

12. An apparatus for reclaiming washing liquid used in an acid gas scrubbing process, comprising a trayed reboiled stripping column with internal heat exchangers on at least some of said trays, plus a liquid flowpath for withdrawing the reclaimed washing liquid from the bottom of said stripper through said heat exchangers.

13. An apparatus for scrubbing CO2 from flue gas comprising a chilled scrubbing medium; an ammonia absorption chilling plant for supplying chilling to said medium; plus a means for transferring heat from said flue gas to said ammonia absorption chilling plant for powering said chilling plant.

14. An apparatus for condensing pressurized CO2 recovered from a flue gas CO2 recovery apparatus comprising: a refrigerated condenser for said pressurized CO2; an ammonia absorption refrigeration plant for supplying refrigeration to said condenser; plus a means for transferring heat from said flue gas to said ammonia absorption refrigeration plant for powering said refrigeration plant.

15. A process for scrubbing CO2 from combustion gas comprising:
a. contacting said gas sequentially in a multistage absorber followed by a multistage washer;
b. circulating a CO2 scrubbing medium between said absorber and a reboiled desorber; and
c. transferring heat inside said desorber between bottom liquid and desorbing liquid.

16. The process according to claim 15 additionally comprising:
a. circulating a water wash medium between said washer and a reboiled water reclaimer;
b. transferring heat inside said reclaimer between bottom liquid and liquid being reclaimed.

17. The process according to claim 16 additionally comprising using aqueous ammonia of at least 7% concentration as said scrubbing medium; and using aqueous ammonia of less than 4% concentration as said water wash medium.

18. The process according to claim 17 additionally comprising cooling and then chilling the reclaimed water wash medium; and supplying said chilling from an ammonia absorption chilling plant powered by waste heat from said combustion gas.

19. The process according to claim 15 additionally comprising: recovering CO2 from said desorber at a pressure of at least 8 ATA; condensing said recovered CO2 with refrigeration; supplying said refrigeration from an ammonia absorption refrigeration plant; and transferring heat from said combustion gas to said absorption refrigeration plant.

20. The process according to claim 18 additionally comprising recovering ammonia from the overhead vapor from said water reclaimer in a non-adiabatic ammonia reclaimer; and washing ammonia from the overhead vapor of said desorber in a non-adiabatic water wash column.
